(19) United States
(12) Patent Application Publication
(10) Pub. No.: US 2009/0063758 A1
(43) Pub. Date: Mar. 5, 2009

(54) PROGRAM AND READ METHOD AND PROGRAM APPARATUS OF NAND FLASH MEMORY

(75) Inventors: Lung-Hao Chang, Hsinchu City (TW); Albert Lee, Hsinchu County (TW); Shun-Ping Wang, Hsinchu County (TW); Chen-Hung Yang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/923,647

(22) Filed: Oct. 24, 2007

(30) Foreign Application Priority Data
Aug. 28, 2007 (TW) 96131833

(51) Int. Cl. G06F 12/00

(52) U.S. Cl. 711/103; 711/E12.001

(57) ABSTRACT

A program method, a read method, and a program apparatus of a NAND flash memory are disclosed. The program method and apparatus of the NAND flash memory provided by the present invention can reduce the programming time of each page and increase the programming speed of the entire NAND flash memory when the data to be programmed in a single operation is less than the storage capacity of all the data storage areas in the page. In addition, the read method of the NAND flash memory provided by the present invention can reduce the number of reading each page and accordingly the number of reading the entire NAND flash memory when the data to be read in a single operation is less than the storage capacity of all the data storage areas in the page.

### CROSS-REFERENCE TO RELATED APPLICATION

This application claims the priority benefit of Taiwan application serial no. 96131833, filed on Aug. 28, 2007. All disclosure of the Taiwan application is incorporated herein by reference.

### BACKGROUND OF THE INVENTION

1. Field of the Invention

The present invention generally relates to a program method and a read method of a NAND flash memory, in particular, to a program method and a program apparatus which can increase the programming speed of a NAND flash memory, and a read method which can reduce the number of reading the NAND flash memory.

2. Description of Related Art

Generally speaking, a NAND flash memory includes a plurality of blocks, and each of the blocks is further divided into a plurality of pages having the same memory capacity, and each page further includes a plurality of data storage areas and a plurality of corresponding spare areas. Taking a page of 2 K bytes+64 bytes for example, the page has 4 data storage areas respectively having a storage capacity of 512 bytes and 4 corresponding spare areas respectively having a storage capacity of 16 bytes. Taking a page of 4 K bytes+128 bytes for example, the page has 8 data storage areas respectively having a storage capacity of 512 bytes and 8 corresponding spare areas having respectively a storage capacity of 16 bytes.

It should be noted that each of foregoing spare areas contains some auxiliary data, such as an error correction code (ECC) and a bad block information etc. The ECC is adopted to increase the reliability in reading data from the data storage areas of each page, and the bad block information is adopted to point out whether a block is a bad block. For example, a block is determined to be a bad block if the first byte in a spare area of the first page or the second page (if the first page is bad) of the block is not equal to 0xFF.

A NAND flash memory has to be programmed or read in unit of pages, and the program/read operation has to be performed sequentially to all the areas in a page starting from the first data storage area until the last spare area. Thus, conventionally, while programming/reading a page, all the data storage areas in the page have to be programmed/read before the corresponding spare areas are programmed/read.

However, taking a page of 2 K bytes+64 bytes or 4 K bytes+256 bytes as example, while programming/reading the page, the data to be programmed/read may not be exactly equal to the storage capacity of all the data storage areas in the page. In this case, the data cannot be programmed into or read from the data storage areas and the corresponding spare areas in the page through a single program/read operation.

Conventionally, when the data to be programmed to or read from a page is not equal to the storage capacity of all the data storage areas in the page and both the data storage areas and the corresponding spare areas in the page have to be programmed/read, a program/read operation is first performed on the page in order to program/read the data storage areas and then another program/read operation is performed on the page in order to program/read the corresponding spare areas.

As described above, conventionally, the data storage areas and the corresponding spare areas in a page of a NAND flash memory cannot be programmed/read within a single program/read operation when the data to be programmed/read is not equal to the storage capacity of all the data storage areas in the page. To resolve this problem, conventionally, multiple program/read operations are performed to the page in order to program/read the data storage areas and the corresponding spare areas in the page.

However, a program operation performed on a NAND flash memory takes about 300 us to complete, so with foregoing resolution, it takes at least 600 us to program a data storage area and a corresponding spare area in a page. Besides, if the addresses of the data storage areas to be programmed in the page are not continuous, the time for programming the page is even longer. Thus, not only the programming speed of the entire NAND flash memory is reduced, but the number of reading the entire NAND flash memory is increased.

### SUMMARY OF THE INVENTION

Accordingly, the present invention is directed to a program method and an apparatus of a NAND flash memory, wherein the time required for programming a page in the NAND flash memory is reduced when the data to be programmed into the page is less than the storage capacity of all the data storage areas in the page, and accordingly the programming speed of the entire NAND flash memory is increased.

The present invention is directed to a read method of a NAND flash memory, wherein the number of reading a page in the NAND flash memory is reduced when the data to be read from the page is less that the storage capacity of all the data storage areas in the page, and accordingly the number of reading the entire NAND flash memory is also reduced.

The present invention provides a program method of a NAND flash memory. The NAND flash memory includes a plurality of pages having the same storage capacity, and each of the pages has n data storage areas and n corresponding spare areas, an end address of the i^{th} data storage area is followed by a start address of the (i+1)^{th} data storage area, an end address of the i^{th} spare area is followed by a start address of the (i+1)^{th} spare area, where n is a positive integer greater than or equal to 2, i is a positive integer smaller than n, and a start address of the 1^{st} spare area is following an end address of the n^{th} data storage area.

The program method of a NAND flash memory provided by the present invention includes following steps: deciding k data storage areas and k corresponding spare areas to be programmed in a first page among the pages when the first page is to be programmed, wherein k is a positive integer smaller than or equal to n; sequentially performing a data loading operation on the 1^{st} data storage area until the n^{th} spare area in the first page, wherein the data loading operation includes following steps: loading predetermined data into the k data storage areas, and loading auxiliary data corresponding to the predetermined data into the k spare areas; loading erasing data into the remaining (n−k) data storage areas and (n−k) spare areas in the first page; and programming the predetermined data and the auxiliary data respectively loaded into the k data storage areas and the k spare areas, and programming the erasing data loaded into the (n−k) data storage areas and the (n−k) spare areas corresponding to the (n−k) data storage areas.

The present invention provides a read method of a NAND flash memory. The method including following steps. First, decide k data storage areas and k corresponding spare areas to be read in a first page among the pages when the first page is to be read, wherein k is a positive integer smaller than or equal to n. Next, sequentially perform a read operation on the 1^{st} data storage area until the n^{th} spare area in the first page, wherein the data reading operation includes following steps. Read predetermined data stored in the k data storage areas, and read auxiliary data corresponding to the predetermined data stored in the k spare areas; un-reading the predetermined data and the auxiliary data respectively stored in the remaining (n−k) data storage areas and (n−k) spare areas in the first page.

The present invention further provides a program apparatus of a NAND flash memory. The program apparatus includes a decision signal generation unit, a decision unit and a control module. The decision signal generation unit generates a decision signal for deciding the k data storage areas and the corresponding k spare areas to be programmed in the first page, wherein k is a positive integer smaller than or equal to n.

The decision unit coupled to decision signal generation unit sequentially performs a data loading operation on the 1^{st} data storage area until the n^{th} spare area in the first page according to the decision signal and a control signal, wherein the data loading operation is to load predetermined data into the k data storage areas, auxiliary data corresponding to the predetermined data into the k spare areas, and erasing data into the remaining (n−k) data storage areas and (n−k) spare areas in the first page.

The control module is coupled to the NAND flash memory, the decision signal generation unit, and the decision unit. The control module generates the control signal and issues a program command to a command register in the NAND flash memory in order to program the predetermined data and auxiliary data respectively loaded in the k data storage areas and the k spare areas and the erasing data loaded in the (n−k) data storage areas and (n−k) spare areas.

According to an embodiment of the present invention, the decision unit includes an assignment unit, a calculation unit, a data supply unit and a selection unit. The assignment unit is coupled to the control module for generating an assignment signal according to the control signal. The calculation unit is coupled to the decision signal generation unit and the assignment unit for generating a selection signal according to the decision signal and the assignment signal. The data supply unit is coupled to the control module for generating a predetermined data, an auxiliary data, and an erasing data according to the control signal. The selection unit is coupled to the calculation unit and the data supply unit for supplying the predetermined data to the k data storage areas, the auxiliary data corresponding to the predetermined data to the k spare areas, and the erasing data to the (n−k) data storage areas and the (n−k) spare areas according to the selection signal.

According to the program method and apparatus of a NAND flash memory provided by the present invention, if the data to be programmed into or read from a page of the NAND flash memory is less than the storage capacity of all the data storage areas in the page, predetermined data and auxiliary data is respectively loaded into the data storage areas and the corresponding spare areas that need to be programmed in the page, and erasing data (digital value FFH) is loaded into the data storage areas and the corresponding spare areas that do not need to be programmed in the page.

Thereby, according to the program method and apparatus of a NAND flash memory provided by the present invention, the predetermined data and auxiliary data is respectively loaded into the data storage areas and the corresponding spare areas that need to be programmed in the page through a single program operation. Compared to the conventional technique, the programming time of each page is reduced and accordingly the programming speed of the entire NAND flash memory is increased in the present invention.

Additionally, according to the read method of a NAND flash memory provided by the present invention, when the data to be read from a page is less than the storage capacity of all the data storage areas in the page, the predetermined data and auxiliary data stored in only the data storage areas and the corresponding spare areas that need to be read in the page is read, and the predetermined data and auxiliary data stored in the data storage areas and the corresponding spare areas that do not need to be read in the page is not read.

Thereby, according to the read method of a NAND flash memory provided by the present invention, the predetermined data and auxiliary data stored in the data storage areas and the corresponding spare areas that need to be read in the page can be read through a single read operation. Accordingly, the liability of reading the data stored in each data storage area in the page is increased, and a bad block in the NAND flash memory can be determined. Moreover, since each page is only read once, the number of reading the entire NAND flash memory is reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a page having a storage capacity of 2 K bytes+64 bytes and a page having a storage capacitor of 4 K bytes+128 bytes.

FIG. 2 is a flowchart illustrating a program method of a NAND flash memory according to an embodiment of the present invention.

FIG. 3 is a circuit block diagram of a program apparatus for a NAND flash memory according to an embodiment of the present invention.

FIG. 4 is a flowchart illustrating a read method of a NAND flash memory according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention is directed to reducing the programming time of each page in a NAND flash memory and increasing the programming speed of the entire NAND flash memory. On the other hand, the present invention is directed to reducing the number of reading each page in the NAND flash memory and increasing the reliability in reading data stored in each page in the NAND flash memory. Embodiments of the present invention will be described below with reference to accompanying drawings so that those skilled in the art can implement the present invention according to the present disclosure.

Generally speaking, a NAND flash memory includes a plurality of blocks, each block is further divided into a plurality of pages having the same storage capacity, and each of the pages has n data storage areas and n corresponding spare areas. The end address of the i^{th} data storage area is followed by the start address of the (i+1)^{th} data storage area, and the end address of the i^{th} spare area is followed by the start address of the (i+1)^{th} spare area, wherein n is a positive integer greater than or equal to 2, and i is a positive integer smaller than n. Besides, the start address of the 1^{st} spare area among the n spare areas follows the end address of the n^{th} data storage area.

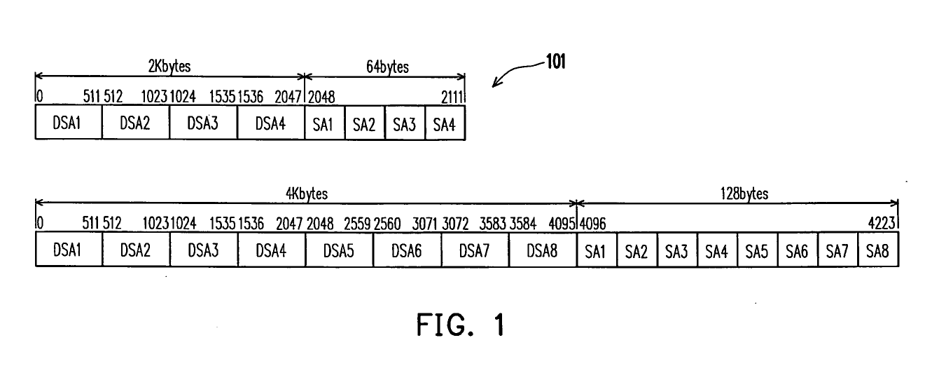

FIG. 1 is a diagram illustrating a page having a storage capacity of 2 K bytes+64 bytes and a page having a storage capacitor of 4 K bytes+128 bytes. Referring to FIG. 1, the page 101 having a storage capacity of 2 K bytes+64 bytes has 4 data storage areas DSA1˜DSA4 of 512 bytes and 4 corresponding spare areas SA1˜SA4 of 16 bytes. The data storage areas DSA1˜DSA4 are used for storing data, while the usage of the spare areas SA1˜SA4 has been described above therefore will not be described herein.

As described above, the end address (511) of the 1^{st} data storage area DSA1 is followed by the start address (512) of the 2^{nd} data storage area DSA2, the end address (1023) of the 2^{nd} data storage area DSA2 is followed by the start address (1024) of the 3^{rd} data storage area DSA3, and the end address (1535) of the 3^{rd} data storage area DSA3 is followed by the start address (1536) of the 4^{th} data storage area DSA4.

Besides, the start address (2048) of the 1^{st} spare area SA1 follows the end address (2047) of the 4^{th} data storage area DSA4, the end address (2063) of the 1^{st} spare area SA1 is followed by the start address (2064) of the 2^{nd} spare area SA2, the end address (2079) of the 2^{nd} spare area SA2 is followed by the start address (2080) of the 3^{rd} spare area SA3, and the end address (2095) of the 3^{rd} spare area SA3 is followed by the start address (2096) of the 4^{th} spare area SA4.

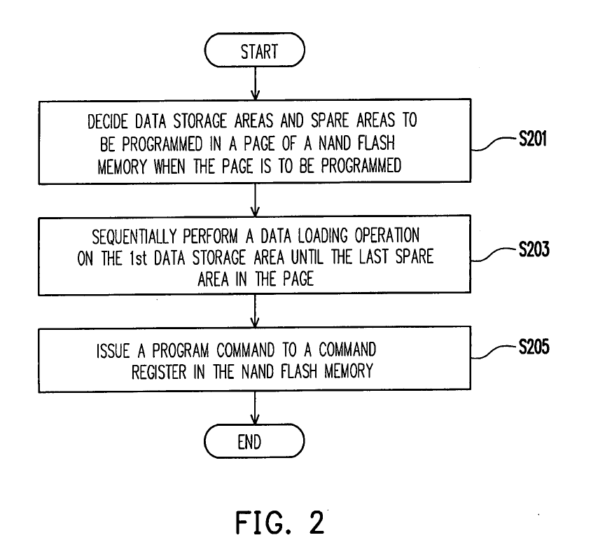

FIG. 2 is a flowchart illustrating a program method of a NAND flash memory according to an embodiment of the present invention. Referring to both FIG. 1 and FIG. 2, in the present embodiment, the program method of the NAND flash memory is described with a page 101 of 2 K bytes+64 byte as an example; however, the present invention is not limited thereto. In the present embodiment, the program method of the NAND flash memory includes following steps. First, in step S201, when the page 101 in a block of the NAND flash memory is to be programmed, k data storage areas and k corresponding spare areas that need to be programmed are decided from the page 101, where k is a positive integer smaller than or equal to n.

In step S201, before programming the page 101, programming software of the NAND flash memory first issues a serial data input command (usually has digital value 80H) to a command register in the NAND flash memory, so as to notify the NAND flash memory that the page 101 thereof is to be programmed.

Besides, the data storage areas and spare areas to be programmed in the page 101 can be decided by assigning the start addresses of the data storage areas DSA1˜DSA4 and the corresponding spare areas SA1˜SA4 which will be programmed in the page 101. Accordingly, the programming software of the NAND flash memory can sequentially determine whether the start address of each of the data storage areas DSA1˜DSA4 and the corresponding spare areas SA1˜SA4 in the page 101 is assigned, wherein the data storage area or spare area is determined as to be programmed if the start address thereof is assigned. For the convenience of description, it is assumed that only the data storage area DSA1 and the corresponding spare area SA1 in the page 101 are to be programmed; however, the present invention is not limited thereto.

As described above, a NAND flash memory has to be programmed or read in unit of pages, and the program/read operation has to be sequentially performed from the first data storage area DSA1 to the last spare area SA4 in the page 101. Thus, in step S203, data is sequentially loaded into the 1^{st} data storage area DSA1 to the 4^{th} spare area SA4 in the page 101. The data loading operation includes following steps. A predetermined data is loaded into the data storage area DSA1, and an auxiliary data corresponding to this predetermined data is loaded into spare area SA1. In addition, erasing data (i.e. digital value FFH) is loaded into the remaining data storage areas DSA2˜DSA4 and spare areas SA2˜SA4 which do not need to be programmed.

Finally, in step S205, a program command is issued to the command register in the NAND flash memory. In the step S205, after all the data has been sequentially loaded into the data storage areas DSA1˜DSA4 and the corresponding spare areas SA1˜SA4 in the page 101, the programming software of the NAND flash memory issues a program command (usually a digital value 10H) to the command register of the NAND flash memory in order to program the predetermined data and the auxiliary data loaded into the data storage area DSA1 and the spare area SA1 and the erasing data loaded into the data storage areas DSA2˜DSA4 and the spare areas SA2˜SA4.

It should be noted that, in the present invention, all the areas (including all the data storage areas and spare areas) in the page are programmed through a single program operation. Please note, in the present invention, the data programmed into each area is different. That is, the predetermined data and the corresponding auxiliary data are stored in specific data storage areas and spare areas (the areas that need to be programmed) are programmed, but erasing data are stored in the other areas.

In the conventional technique, since the data stored in the data storage areas and the corresponding spare areas in a page cannot be programmed through a single program operation when the data to be programmed is not equal to the storage capacity of all the data storage areas in the page, the program operation has to be performed several times on the page such that the data stored in both the data storage areas and the corresponding spare areas can be programmed completely. However, as described above, in the present invention, the data in all the data storage areas and the corresponding spare areas in a page are programmed through a single program operation; therefore foregoing problem is resolved in the present invention.

In other words, in the present invention, a “real” program operation is performed on the areas that need to be programmed in a page, and a “pseudo” program operation is performed on the areas that need not to be programmed in the page (which is accomplished by loading the erasing data into these areas). As is well known by those skilled in the art, a program operation can only change the status of a memory unit in a NAND flash memory from logic 1 to logic 0 but not from logic 0 to logic 1. Only the erasing operation has the ability to change the status of the memory unit from logic 0 to logic 1. Thus, the existing data in the data storage areas and spare areas, which are not to be programmed, will not be affected if the erasing data, used for programming these data storage areas and the spare areas, carry the digital value FFH (this means each of the bits carried by the erasing data is logic 1).

Accordingly, in the present invention, all the areas that need to be programmed in a page can be programmed through a single program operation. As described above, such an operation spends about 300 us. In contrast to the conventional technique (wherein a program operation takes at least 600 us), the program operation in the present invention saves at least half of the time.

Additionally, in the present embodiment, in order to know whether the program operation performed to the data storage areas DSA1˜DSA4 and the corresponding spare areas SA1˜SA4 has been completed so that the programming software of the NAND flash memory can continue to program another page, the programming software continuously detects the signal status of a ready/busy (R/B) pin of a status register in the NAND flash memory after the programming software of the NAND flash memory has issued a program command to the command register in the NAND flash memory.

Accordingly, the programming operation performed to the predetermined data and the auxiliary data respectively loaded into the data storage area DSA1 and the spare area SA1 and the erasing data loaded into the data storage area DSA2˜DSA4 and the spare areas SA2˜SA4 is completed when the programming software of the NAND flash memory detects that the signal status of the R/B pin of the status register is logic 1. The programming software of the NAND flash memory then continues to program another page.

However, it does not mean that the predetermined data and the auxiliary data respectively loaded into the data storage area DSA1 and the spare area SA1 and the erasing data loaded into the data storage area DSA2˜DSA4 and the spare areas SA2˜SA4 has been programmed successfully when the program operation performed thereto is completed.

In the present embodiment, in order to make sure that the predetermined data and the auxiliary data respectively loaded into the data storage area DSA1 and the spare area SA1 and the erasing data loaded into the data storage areas DSA2˜DSA4 is programmed successfully, the signal status of a pass/fail pin of the status register in the NAND flash memory has to be detected after the programming software of the NAND flash memory has detected that the signal status for the R/B pin of the status register is logic 1.

The predetermined data and the auxiliary data respectively loaded into the data storage area DSA1 and the spare area SA1 and the erasing data loaded into the data storage area DSA2˜DSA and the spare areas SA2˜SA4 has been programmed successfully if the programming software of the NAND flash memory detects that the signal status of the pass/fail pin of the status register is logic 0. Otherwise, the programming software of the NAND flash memory performs the program operation (steps S201˜S205) to the page 101 again.

In order to realize the advantages of the program method for the NAND flash memory described above, a program apparatus for the NAND flash memory will be described below, so that those skilled in the art can understand the spirit of the present invention more clearly.

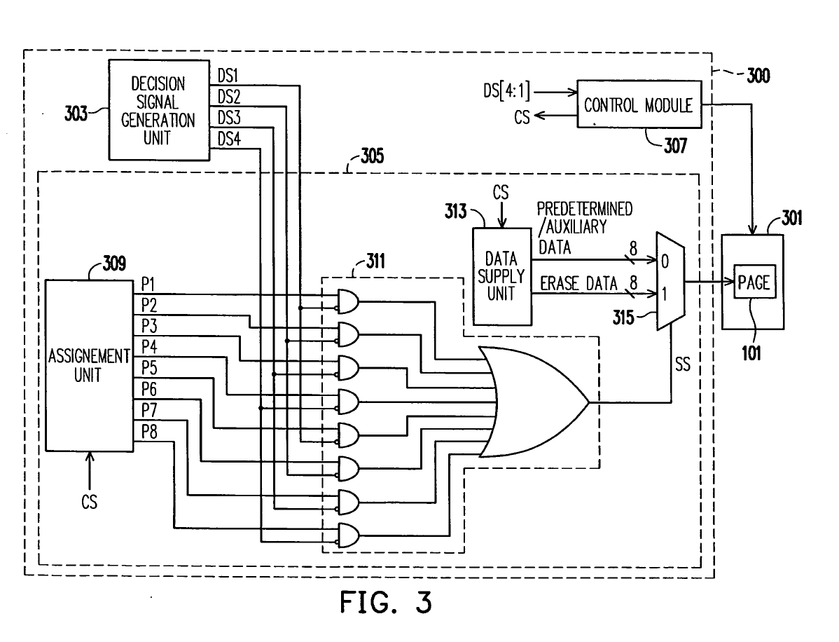

FIG. 3 is a circuit block diagram of a program apparatus 300 for a NAND flash memory 301 according to an embodiment of the present invention. Referring to both FIG. 1 and FIG. 3, in the present embodiment, the program apparatus 300 for the NAND flash memory 301 will also be described with a page 101 having a storage capacity of 2 K bytes+64 bytes; however the present invention is not limited thereto. In the present embodiment, the program apparatus 300 for the NAND flash memory 301 includes a decision signal generation unit 303, a decision unit 305, and a control module 307.

In the present embodiment, before programming the page 101 in the NAND flash memory 301, the control module 307 issues a serial data input command (digital value 80H) to a command register (not shown) in the NAND flash memory 301 in order to notify the NAND flash memory 301 that the page 101 is to be programmed.

Next, the decision signal generation unit 303 generates a 4-bit decision signal DS[4:1] to decide k data storage areas and k corresponding spare areas to be programmed in the page 101. In the present embodiment, the status of the 4-bit decision signal DS[4:1] generated by the decision signal generation unit 303 specifies the start addresses of the data storage areas DSA1˜DSA4 and the corresponding spare areas SA1˜SA4 that to be programmed in the page 101.

For the convenience of description, it is also assumed that only the data storage area DSA1 and the corresponding spare area SA1 in the page 101 are to be programmed; however, the present invention is not limited thereto. Accordingly, the status of the 4-bit decision signal DS[4:1] generated by the decision signal generation unit 303 is set to 0001B.

It should be mentioned here that the control module 307 determines the start addresses of the data storage areas DSA1˜DSA4 and the corresponding spare areas SA1˜SA4 that will be programmed in the page 101 according to the 4-bit decision signal DS[4:1] generated by the decision signal generation unit 303 and generates a control signal CS accordingly in order to control the operations of an assignment unit 309 and a data supply unit 313 in the decision unit 305.

The decision unit 305 is coupled to the decision signal generation unit 303 and the control module 307, and the decision unit 305 sequentially loads data into the 1^{st} data storage area DSA1 until the 4^{th} spare area SA4 according to the 4-bit decision signal DS[4:1] generated by the decision signal generation unit 303 and the control signal CS generated by the control module 307. The data loading operation has been described in foregoing embodiment therefore will not be described herein.

In the present embodiment, the decision unit 305 includes the assignment unit 309, a calculation unit 311, the data supply unit 313 and a selection unit 315. The assignment unit 309 is coupled to the control module 307 and generates an 8-bit assignment signal P[8:1] according to the control signal CS generated by the control module 307. Since in the present embodiment, it is assumed that only the data storage area DSA1 and the corresponding spare area SA1 in the page 101 are to be programmed, the status of the assignment signal P[4:1] is respectively kept at logic 1 for 512 times from the assignment signal P1 to the assignment signal P4. After that, the status of the assignment signal P[8:5] is kept at logic 1 respectively for 16 times from the assignment signal P5 to the assignment signal P8.

The calculation unit 311 is coupled to the decision signal generation unit 303 and the assignment unit 309 and generates a selection signal SS according to the 4-bit decision signal DS[4:1] generated by the decision signal generation unit 303 and the 8-bit assignment signal P[8:1] generated by the assignment unit 309. In the present embodiment, the calculation unit 311 is a digital circuit composed of 8 NOT gates, 8 AND gates, and a OR gate; however, the structure of the calculation unit 311 is not limited thereto, and the operations of these components should be understood by those having ordinary knowledge in the art therefore will not be described herein.

The data supply unit 313 is coupled to the control module 307. The data supply unit 313 generates 512 predetermined data when the decision signal DS1 and the assignment signal P1 are both at logic 1, generates the auxiliary data corresponding to the 512 predetermined data when the decision signal DS1 and the assignment signal P5 are both at logic 1, and generates the erasing data when the decision signal DS[4:2] and the assignment signals P[4:2]˜P[8:6] are respectively at logic 0 and logic 1 according to the control signal CS generated by the control module 307.

The selection unit 315 is coupled to the calculation unit 311 and the data supply unit 313. The selection unit 315 provides the 512 predetermined data generated by the data supply unit 313 to the 512 bytes (i.e. 0˜511) of the data storage area DSA1, provides the 16 auxiliary data corresponding to the 512 predetermined data generated by the data supply unit 313 to the 16 bytes (i.e. 2048˜2063) of the spare area SA1, and provides the erasing data generated by the data supply unit 313 to the data storage area DSA2˜DSA4 and the spare area SA2˜SA4 according to the selection signal SS generated by the calculation unit 311.

Referring to FIG. 1 and FIG. 3 again, after the data (including the predetermined data, the auxiliary data, and the erasing data) has been loaded into the data storage areas DSA1˜DSA4 and the corresponding spare areas SA1˜SA4 in the page 101, the control module 307 issues a program command (digital value 10H) to the command register in the NAND flash memory 301 to program the predetermined data and the auxiliary data respectively loaded into the data storage area DSA1 and the corresponding spare area SA1 and the erasing data loaded into the data storage areas DSA2˜DSA4 and the spare areas SA2˜SA4.

Next, after the control module 307 has issued the program command (digital value 10H) to the command register in the NAND flash memory 301, the control module 307 keeps detecting the signal status of a R/B pin of a status register in the NAND flash memory 301. The program operation performed to the predetermined data and the auxiliary data respectively loaded into the data storage area DSA1 and the spare area SA1 and the erasing data loaded into the data storage areas DSA2˜DSA4 and the spare areas SA2˜SA4 has been completed when the signal status of the R/B pin is detected to be logic 1.

After that, the control module 307 further detects the signal status of a pass/fail pin of the status register in the NAND flash memory 301 after it has detected that the signal status of the RIB pin of the status register in the NAND flash memory 301 is logic 1. The page 101 has been programmed successfully when the signal status of the pass/fail pin is detected to be logic 0. Otherwise, the control module 307 programs the page 101 again.

As described above, in the present embodiment, the program method and apparatus of the NAND flash memory load the predetermined data and the auxiliary data respectively into the data storage area DSA1 and the corresponding spare area SA1 that will be programmed in the page 101 and load the erasing data into the data storage areas DSA2˜DSA4 and the corresponding spare areas SA2˜SA4 that will not be programmed in the page 101 when the data to be programmed in the page 101 through a single program operation is less than the storage capacity of all the data storage areas DSA1˜DSA4 in the page 101.

Thereby, the program method and apparatus for the NAND flash memory in the present embodiment can program the data storage area DSA1 and the corresponding spare area SA1 in the page 101 through a single program operation. Compared to the conventional technique, the time required for programming each page is reduced and accordingly the programming speed of the entire NAND flash memory is increased in the present embodiment.

A read method for the NAND flash memory will be described below. Through this method, the number for reading each page in the NAND flash memory is reduced and the reliability in reading data stored in each page of the NAND flash memory is improved.

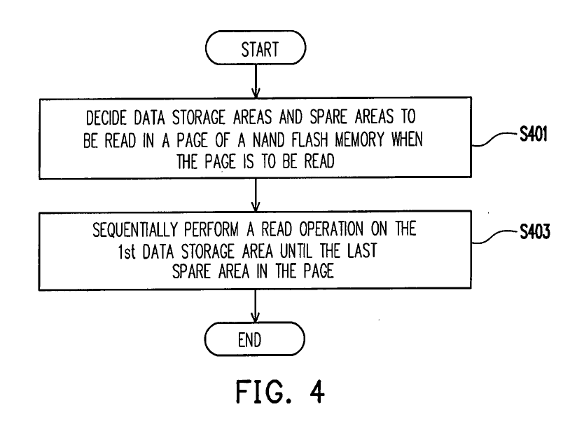

FIG. 4 is a flowchart illustrating a read method of a NAND flash memory according to an embodiment of the present invention. Refer to both FIG. 1 and FIG. 4, in the present embodiment, the read method for the NAND flash memory is also described with the page 101 having a storage capacity of 2 K bytes+64 bytes as an example; however, the present invention is not limited thereto. In the present embodiment, the read method for the NAND flash memory includes following steps. First, in step S401, when the page 101 in the NAND flash memory is to be read, k data storage areas and k corresponding spare areas that will be read are decided in the page 101.

In the embodiment, before the page 101 is read, read software of the NAND flash memory issues a read command (usually having digital value OOH) to a command register in the NAND flash memory in order to notify the NAND flash memory that the page 101 is to be read.

Besides, in step S401, the k data storage areas and the corresponding k spare areas that to be read in the page 101 can be decided by assigning the start addresses of the data storage areas DSA1˜DSA4 and the corresponding spare areas in the page 101. Accordingly, the read software of the NAND flash memory can sequentially determine whether the start address of each of the data storage areas DSA1˜DSA4 and the corresponding spare areas SA1˜SA4 in the page 101 is assigned. Please note, the data storage area or spare area is regarded as to be read if the start address thereof is assigned. For the convenience of description, it is assumed that only the data storage area DSA1 and the corresponding spare area SA1 in the page 101 are to be read; however, the present invention is not limited thereto.

As described above, the NAND flash memory has to be programmed or read in unit of pages, and the program/read operation has to be sequentially performed from the first data storage area DSA1 to the last spare area SA4 in the page 101. Thus, in step S403, data is sequentially read from the 1^{st} data storage area DSA1 to the 4^{th} spare area SA4 in the page 101. The read operation includes following steps. The predetermined data stored in the data storage area DSA1 is read, and the auxiliary data corresponding to this predetermined data stored in the spare area SA1 is also read. In addition, the predetermined data and auxiliary data respectively stored in the remaining data storage areas DSA2˜DSA4 and spare areas SA2˜SA4 is not read (for example, the predetermined data and auxiliary data stored in the remaining data storage areas and spare areas can be shadowed).

In the present embodiment, the read software of the NAND flash memory further issues a read confirmation command (usually having a digital value 30H) to the command register in the NAND flash memory after the read software of the NAND flash memory has decided the data storage area DSA1 and the corresponding spare area SA1 to be read in the page 101. The read software of the NAND flash memory starts reading from the data storage area DSA1 and the corresponding spare area SA1 in the page 101 after a waiting period (i.e. the period for the signal status of the R/B pin of the status register in the NAND flash memory detected by the read software of the NAND flash memory to change from logic 0 to logic 1).

Moreover, the read software of the NAND flash memory keeps detecting the signal status of the RIB pin of the status register in the NAND flash memory in order to determine whether the read operation performed to the first page has been completed. The read operation performed to the page 101 is completed when the signal status of the RIB pin is logic 1. Then the read software of the NAND flash memory continues to read another page.

As described above, in the present embodiment, when the data to be read from the page 101 is less than the storage capacity of all the data storage areas DSA1˜DSA4 in the page 101, only the predetermined data and the auxiliary data respectively stored in the data storage area DSA1 and the corresponding spare area SA1 in the page 101 is read, while the predetermined data and the auxiliary data respectively stored in the data storage areas DSA2˜DSA4 and the corresponding spare areas SA2˜SA4 is not read or shadowed.

Thereby, according to the read method for the NAND flash memory in the present embodiment, the predetermined data and the auxiliary data respectively stored in the data storage area and the corresponding spare area that will be read in the page can be read through a single read operation. Thus, the reliability in reading data stored in each data storage area in the page is increased, and bad blocks in the NAND flash memory can be determined. Moreover, since each page is read only once, the number of reading the entire NAND flash memory is reduced.

In summary, according to the program method and apparatus for a NAND flash memory provided by the present invention, the time required for programming each page is reduced and accordingly the programming speed of the entire NAND flash memory is increased when the data to be programmed through a single program operation is less than the storage capacity of all the data storage areas in the page. Moreover, according to the read method for a NAND flash memory provided by the present invention, the number of reading each page is reduced and accordingly the time for reading the entire NAND flash memory is also reduced when the data to be programmed through a single program operation is less than the storage capacity of all the data storage areas in the page.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A program method for a NAND flash memory, the NAND flash memory comprising a plurality of pages having a same storage capacity, each of the pages having n data storage areas and n corresponding spare areas, an end address of the i^{th} data storage area followed by a start address of the (i+1)^{th} data storage area, an end address of the i^{th} spare area followed by a start address of the (i+1)^{th} spare area, n being a positive integer greater than or equal to 2, i being a positive integer smaller than n; a start address of the 1^{st} spare area following an end address of the n^{th} data storage area, and the program method comprising:
deciding k data storage areas and k corresponding spare areas to be programmed in a first page among the pages when the first page is to be programmed, wherein k is a positive integer smaller than or equal to n;
sequentially performing a data loading operation on the 1^{st} data storage area until the n^{th} spare area in the first page, wherein the data loading operation comprises:
loading predetermined data into the k data storage areas, and loading auxiliary data corresponding to the predetermined data into the k spare areas; and
loading erasing data into the remaining (n−k) data storage areas and (n−k) spare areas in the first page; and
programming the predetermined data and the auxiliary data respectively loaded into the k data storage areas and the k spare areas, and programming the erasing data loaded into the (n−k) data storage areas and the (n−k) spare areas corresponding to the (n−k) data storage areas.

2. The program method according to claim 1 further comprising:
issuing a serial data input command to a command register in the NAND flash memory before programming the first page in order to notify the NAND flash memory that the first page in the NAND flash memory is to be programmed.

3. The program method according to claim 1, wherein the step of deciding the k data storage areas and the k corresponding spare areas to be programmed in the first page comprises:
sequentially determining whether the start addresses of each storage area and the corresponding spare area in the first page have been assigned, wherein if the start addresses of the storage area and the corresponding spare area in the first page have been assigned, then determining that the data storage area and the corresponding spare area are to be programmed.

4. The program method according to claim 1 further comprising:
issuing a program command to the command register in the NAND flash memory in order to program the predetermined data and the auxiliary data respectively loaded into the k data storage areas and the k spare areas and the erasing data loaded into the (n−k) data storage areas and the (n−k) spare areas after the data loading operation is performed on the first page.

5. The program method according to claim 4 further comprising:
detecting a signal status of a ready/busy (R/B) pin of a status register in the NAND flash memory in order to determine whether the predetermined data and the auxiliary data respectively loaded into the k data storage areas and the k spare areas and the erasing data loaded into the (n−k) data storage areas and the (n−k) spare areas have been programmed after the program command is issued to the command register; and
determining that the predetermined data and the auxiliary data respectively loaded into the k data storage areas and the k spare areas and the erasing data loaded into the (n−k) data storage areas and the (n−k) spare areas have been programmed if the signal status of the R/B pin is logic 1.

6. The program method according to claim 5 further comprising:
detecting a signal status of a pass/fail pin of the status register in order to determine whether the first page has been programmed successfully after the predetermined data and the auxiliary data respectively loaded into the k data storage areas and the k spare areas and the erasing data loaded into the (n−k) data storage areas and the (n−k) spare areas have been programmed; and
determining that the first page has been programmed successfully if the signal status of the pass/fail pin is logic 0.

7. A read method for a NAND flash memory, the NAND flash memory comprising a plurality of pages having a same storage capacity, each of the pages having n data storage areas and n corresponding spare areas, an end address of the i^{th} data storage area followed by a start address of the (i+1)^{th} data storage area, an end address of the i^{th} spare area followed by a start address of the (i+1)^{th} spare area, n being a positive integer greater than or equal to 2, i being a positive integer smaller than n; a start address of the 1^{st} spare area following an end address of the n^{th} data storage area, and the read method comprising:
deciding k data storage areas and k corresponding spare areas to be read in a first page among the pages when the first page is to be read, wherein k is a positive integer smaller than or equal to n; and
sequentially performing a read operation on the 1^{st} data storage area until the n^{th} spare area in the first page, wherein the read operation comprises:
reading predetermined data stored in the k data storage areas, and reading auxiliary data corresponding to the predetermined data stored in the k spare areas; and
un-reading the predetermined data and the auxiliary data respectively stored in the remaining (n−k) data storage areas and (n−k) spare areas in the first page.

8. The read method according to claim 7 further comprising:
issuing a read command to a command register in the NAND flash memory before reading the first page in order to notify the NAND flash memory that the first page in the NAND flash memory is to be read.

9. The read method according to claim 7, wherein the step of deciding the k data storage areas and the corresponding k spare areas to be read in the first page comprises:
sequentially determining whether the start addresses of each storage area and the corresponding spare area in the first page have been assigned; and
determining that the data storage area and the corresponding spare area in the first page are to be read if the start addresses of the storage area and the corresponding spare area in the first page have been assigned.

10. The read method according to claim 7 further comprising:
issuing a read confirmation command to the command register in the NAND flash memory and starting to perform the read operation to the first page through a waiting period after deciding the k data storage areas and the k corresponding spare areas in the first page.

11. The read method according to claim 7 further comprising:
detecting a signal status of a R/B pin of a status register in the NAND flash memory after performing the read operation to the first page in order to determine whether the first page has been read; and
determining that the first Page has been read if the signal status of the R/B pin is logic 1.

12. A program apparatus for a NAND flash memory, the NAND flash memory comprising a plurality of pages having a same storage capacity, each of the pages having n data storage areas and n corresponding spare areas, an end address of the i^{th} data storage area followed by a start address of the (i+1)^{th} data storage area, an end address of the i^{th} spare area followed by a start address of the (i+1)^{th} spare area, n being a positive integer greater than or equal to 2, i being a positive integer smaller than n; a start address of the 1^{st} spare area following an end address of the n^{th} data storage area, and the program apparatus comprising:
a decision signal generation unit, for generating a decision signal for deciding k data storage areas and k corresponding spare areas to be programmed in a first page among the pages, wherein k is a positive integer smaller than or equal to n;
a decision unit, coupled to the decision signal generation unit, for sequentially performing a data loading operation on the 1^{st} data storage area until the n^{th} spare area in the first page according to the decision signal and a control signal, wherein the data loading operation is to load predetermined data into the k data storage areas, auxiliary data corresponding to the predetermined data into the k spare areas, and erasing data into the remaining (n−k) data storage areas and (n−k) spare areas in the first page; and
a control module, coupled to the NAND flash memory, the decision signal generation unit and the decision unit, for generating the control signal and issuing a program command to a command register in the NAND flash memory in order to program the predetermined data and the auxiliary data respectively loaded into the k data storage areas and the k spare areas and the erasing data loaded into the (n−k) data storage areas and the (n−k) spare areas;
wherein the control module generates the control signal according to a status of the decision signal.

13. The program apparatus according to claim 12, wherein the control module further issues a serial data input command to the command register before programming the first page in order to notify the NAND flash memory that the first page is to be programmed.

14. The program apparatus according to claim 12, wherein the decision unit comprises:
an assignment unit, coupled to the control module, for generating an assignment signal according to the control signal;
a calculation unit, coupled to the decision signal generation unit and the assignment unit, for generating a selection signal according to the decision signal and the assignment signal;
a data supply unit, coupled to the control module, for generating the predetermined data, the auxiliary data, and the erasing data according to the control signal; and
a selection unit, coupled to the calculation unit and the data supply unit, for providing the predetermined data to the k data storage areas, the auxiliary data corresponding to the predetermined data to the k spare areas, and the erasing data to the (n−k) data storage areas and the (n−k) spare areas according to the selection signal.

15. The program apparatus according to claim 12, wherein the control module further detects a signal status of a R/B pin of a status register in the NAND flash memory after issuing the program command to the command register in order to determine whether the predetermined data and the auxiliary data respectively loaded into the k data storage areas and the k spare areas and the erasing data loaded into the (n−k) data storage areas and the (n−k) spare areas have been programmed;
wherein the control module determines that the predetermined data and the auxiliary data respectively loaded into the k data storage areas and the k spare areas and the erasing data loaded into the (n−k) data storage areas and the (n−k) spare areas have been programmed if the control module detects that the signal status of the R/B pin is logic 1.

16. The program apparatus according to claim 15, wherein the control module further detects a signal status of a pass/fail pin of the status register in order to determine whether the first page has been programmed successfully after the predetermined data and the auxiliary data respectively loaded into the k data storage areas and the k spare areas and the erasing data loaded into the (n−k) data storage areas and the (n−k) spare areas have been programmed;
wherein the control module determines the first page has been programmed successfully if the control module detects that the signal status of the pass/fail pin is logic 0.
